(19) United States
(12) Patent Application Publication
(10) Pub. No.: US 2011/0246380 A1
(43) Pub. Date: Oct. 6, 2011

(54) LOCATING TECHNOLOGY CENTERS IN AN ORGANIZATION USING A PATENT SEARCH ENGINE

(75) Inventors: Jason David Resnick, Clifton, VA (US); Randy W. Lacasse, Fairfax Station, VA (US)

(73) Assignee: CPA GLOBAL PATENT RESEARCH LIMITED, St. Helier (JE)

(21) Appl. No.: 12/754,358

(22) Filed: Apr. 5, 2010

(51) Int. Cl. G06Q 99/00; G06F 17/30; G06Q 10/00

(52) U.S. Cl. 705/310; 707/706; 705/320; 707/E17.014

(57) ABSTRACT

A search platform that can locate a technology center within an organization using a patent search engine. Since organizational resources tend to be associated with patents or patent-related projects from a technical standpoint, the search platform can utilize these associations to identify particular technology centers within the organization. By searching patent collections and organizational workspaces associated with patents to obtain information on an organization's technology centers, the search platform can provide business intelligence to the organization without the need for a dedicated knowledge network to be built and maintained by the organization.

### FIELD OF THE DISCLOSURE

The disclosure of the present application relates to collaborative work environments, including a search platform that can locate organizational information by searching patent documents and other technical documents.

### BACKGROUND

Advances in technology can enable large organizations to support a collaborative work environment across multiple office locations. For example, in a large global organization having tens of thousands of employees, employees within particular divisions or groups may be scattered across the world, yet they can utilize collaborative enterprise software, for example, to work together on various projects.

Unfortunately, when an organization has a large number of employees and divisions, it can be difficult to identify its particular technology centers at any particular time. A technology center refers to any organizational resource, such as a particular person, division or technical solution, for example, that is associated with the organization.

Due to this difficulty, it can be unclear which employees are associated with which projects, and whether certain projects in one division of the organization are duplicative of other projects in other divisions. This can lead to a duplication of effort across the organization, resulting in an unproductive and inefficient work environment.

### SUMMARY

A search platform is disclosed that can locate a technology center within an organization using a patent search engine. Since organizational resources tend to be associated with patents or patent-related projects from a technical standpoint, the search platform can utilize these associations to identify particular technology centers within the organization. By searching patent collections and organizational workspaces associated with patents to obtain information on an organization's technology centers, the search platform can provide business intelligence to the organization without the need for a dedicated knowledge network to be built and maintained by the organization.

In one embodiment, a search engine can identify a technology center (e.g., employees, divisions, projects, and/or solutions associated with the organization) by searching patent documents. A user operating a client computer can provide a request to the search engine to identify a technology center within the organization within which the search engine is deployed. The request can include one or more search terms. In response to the request, the search engine can conduct a search for patent documents associated with the organization that have a similarity to the provided search terms. If the search engine determines that one or more patent documents associated with the organization have a similarity to the provided search terms, the search engine can identify a technology center within the organization based on the matched documents. Once identified, the client computer can receive the identified technology center provided by the search engine in response to the request.

The embodiments comprise methods, systems, and devices that provide various techniques for the search engine to conduct a search. Based upon the information associated with the received request, the search engine can generate a query to implement a search of patent documents. In one embodiment, the search engine can use an assignee field search limitation to identify patent documents that are associated with the organization. The search engine can then employ a vector based search methodology to identify patent documents that have a similarity to the provided search terms.

The ways in which the search engine can identify a technology center within the organization can be widely varied. In one embodiment, the search engine can cross-reference extracted patent document information (e.g., inventor information) with organizational resources (e.g., employees or divisions) to identify a technology center. In another embodiment, the search engine can provide extracted patent document information (e.g., technical solutions) to identify a technology center.

The search engine can also provide a mechanism by which the client computer can contact or retrieve further information on the requested technology center identified by the search engine. In particular, the search engine can provide a user interface that both identifies the requested technology center and enables the client computer to contact or retrieve further information on the requested technology center.

### BRIEF DESCRIPTION OF THE DRAWINGS

FIG. 1 illustrates an exemplary a search platform architecture;

FIG. 2 illustrates an exemplary process for identifying a technology center;

FIG. 3 illustrates an exemplary process for searching a patent collection;

FIG. 4 illustrates an exemplary process for identifying a technology center;

FIG. 5 illustrates an exemplary process for identifying a technology center;

FIG. 6 illustrates an exemplary request screen for locating an employee associated with an organization;

FIG. 7 illustrates an exemplary result screen for locating an employee associated with an organization;

FIG. 8 illustrates another exemplary result screen for locating an employee associated with an organization;

FIG. 9 illustrates an exemplary result screen for locating a division associated with an organization;

FIG. 10 illustrates an exemplary result screen for locating a solution associated with an organization; and

FIG. 11 illustrates an example of a computing device capable of implementing the embodiments shown in FIGS. 1-10.

### DETAILED DESCRIPTION

The present disclosure is directed to a search platform that can locate a technology center within an organization by searching patent documents. Since organizational resources tend to be associated with patents or patent-related projects from a technical standpoint, the search platform can utilize these associations to identify particular technology centers within the organization.

By searching patent collections and/or organizational workspaces associated with patent documents to obtain information on an organization's technology centers, the search platform can provide business intelligence to the organization without the need for a dedicated knowledge network to be built and maintained by the organization.

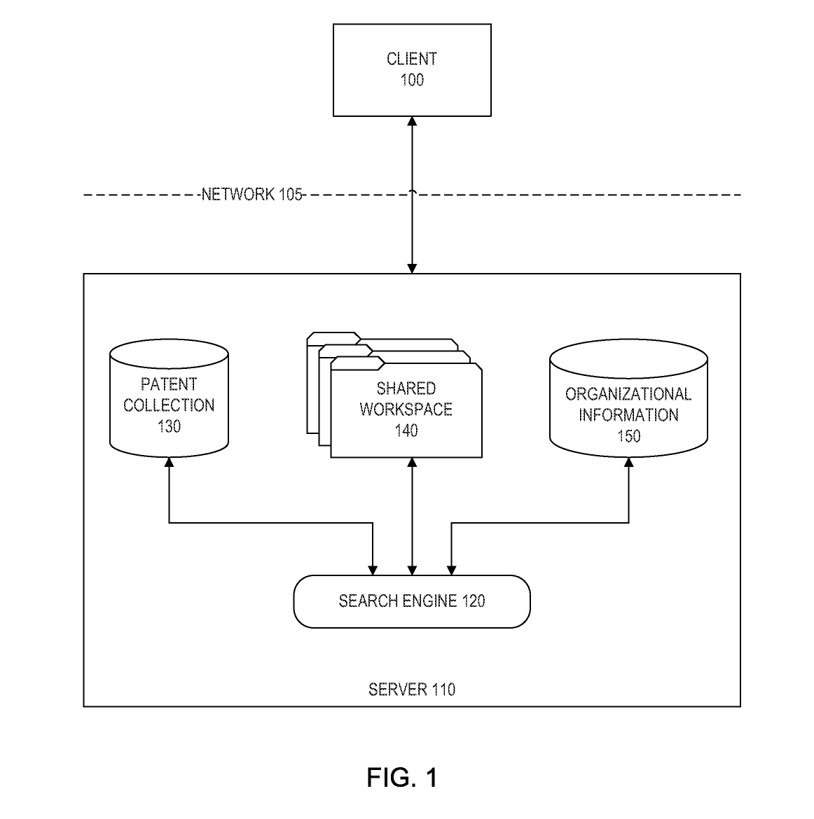

FIG. 1 illustrates an embodiment of a search platform architecture deployed within an organization. In the illustrated embodiment, a user operating client 100 can access server 110 across network 105. Server 110 can deploy search engine 120, which can be associated with patent collection 130, shared workspace 140 and organizational information 150.

Patent collection 130 can include one or more databases storing patent documents, such as patents and/or patent publications for example, associated with one or more national patent offices. Shared workspace 140 can include a storage area accessible to multiple users associated with the organization, and can define distinct workspaces associated with an organization entity, such as a division of the organization and/or one or more users associated with the organization for example. Work files associated with one or more projects and/or users associated with the organization can be stored in shared workspace 140. Work files can include documents or data, such as patent documents, patent disclosures or user's notes for example. Data generated by search engine 120 based on usage of search engine 120 by users of the organization can also be stored in shared workspace 140. This data can include, for example, log data relating to the activity of users in connection with search engine 130. Organizational information 150 can include one or more databases storing data associated with the organization, such as human resources data for example.

The manner in which search engine 120 can be deployed within an organization can be widely varied. For example, in the embodiment illustrated in FIG. 1, search engine 120 can be installed on one or more servers of the organization and operated by the organization. This can simplify configuration and access of search engine 120 to the organization's electronic resources (e.g., particular databases, workspaces, etc.) in accordance with teachings of the present disclosure. In another embodiment, search engine 120 can be hosted and operated by a third party, and be granted remote access to the organization's electronic resources in accordance with teachings of the present disclosure. Similarly, patent collection 130 can be installed and managed locally to the organization, or hosted and managed by a third party in accordance with teachings of the present disclosure.

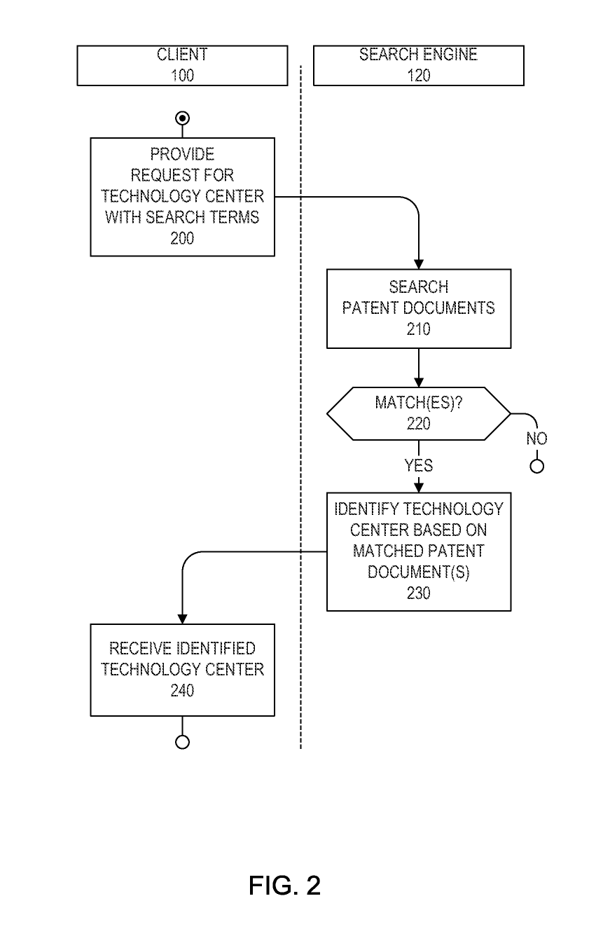

FIG. 2 illustrates an embodiment of a process for identifying a technology center by searching patent documents. In the illustrated embodiment, client 100 can provide (block 200) a request to search engine 120 to identify a technology center within the organization within which search engine 120 is deployed. The request can include one or more search terms for example. In response to the request, search engine 120 can conduct (block 210) a search for patent documents associated with the organization that have a similarity to the provided search terms. If search engine 120 determines (block 220) that no patent document associated with the organization has a similarity to the provided search terms, the process can terminate. This termination can include search engine 120 providing an indication to client 100 that no relevant information was found in response to the request. If search engine 120 determines (block 220) that one or more patent documents associated with the organization have a similarity to the provided search terms, search engine 120 can identify (block 230) a technology center within the organization based on the matched documents. Once identified, client 100 can receive (block 240) the identified technology center provided by search engine 120 in response to the request.

The ways in which search engine 120 can conduct the search as specified in block 210 can be widely varied. Based upon the information associated with the received request, search engine 120 can generate a query to implement a search of patent documents. In one embodiment, for example, search engine 120 can use an assignee field search limitation to identify patent documents that are associated with the organization, and can employ a vector based search methodology to identify patent documents that have a similarity to the provided search terms.

In connection with the assignee field search limitation, search engine 120 can append to the generated query a search limitation that associates one or more names associated with the organization with an assignee field to be searched among patent documents. Since the organization can have or be part of one or more corporate divisions (i.e., distinct corporate entities in the corporate tree affiliated with the organization), search engine 120 can specify one or more corporate divisions in the organization's corporate tree in the assignee field search limitation to reduce the risk of missing a patent document that is associated with the organization. Search engine 120 can also specify prior names associated with the organization, such as a name of the organization before a merger, for example. This can improve the likelihood of the search capturing patent documents that were associated with the organization when the organization was known by a different name.

In one embodiment, for example, search engine 120 can provide a listing of divisions in the organization's corporate tree to client 100 to enable a user to select a particular division within which search engine 120 is to identify the requested technology center. The corporate tree listing can be provided to client 100 before or after the patent documents are searched, for example. In another embodiment, search engine 120 can automatically specify one or more names associated with the organization in the assignee field search limitation, so that a user need not independently identify the organization when formulating a request for a technology center. Further, search engine 110 can require an exact assignee match in connection with the specified organization name(s) to reduce the risk of returning patent documents with assignee names different than, but similar to, the specified organization name(s).

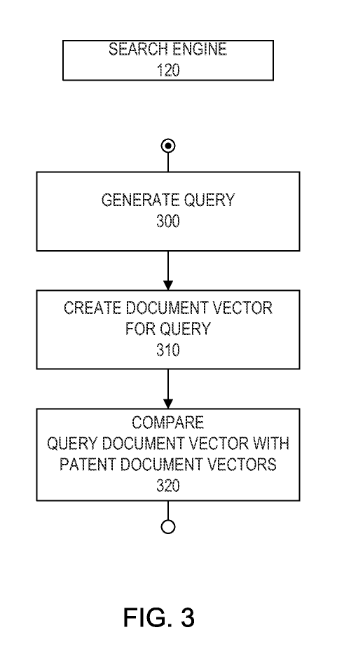

In connection with the vector based search methodology, search engine 120 can employ such a methodology with the generated query to identify patent documents that have a similarity to the provided search terms. As illustrated in the embodiment of FIG. 3, for example, search engine 120 can generate a query (block 300) based on information associated with the received request, such as an assignee field search limitation and provided search terms for example. Search engine 120 can subsequently create (block 310) a document vector for the query. For example, the document vector can be a weighted list of words and phrases, such as:
[table, 1][chair, 0.5][plate, 0.2]
   as a simplified example. Once the query document vector is created, search engine 120 can compare (block 320) the query document vector with retrieved document vectors that have been previously created for each of the patent documents to be searched (e.g., in patent collection 130 and/or shared workspace 140). The comparison can include, for example, multiplying the weights of any common terms among the query document vector and each retrieved document vector, and adding the results to obtain a similarity ranking. Taking another simplified example:
query document vector: [table, 1][chair, 0.5][plate, 0.2]
retrieved document vector: [cup, 1][saucer, 0.7][chair, 0.6][plate, 0.5]
similarity=0.5*0.6+0.2*0.5=0.4
   If the similarity ranking exceeds a predefined threshold, search engine 120 can consider the patent document associated with the retrieved document vector to be a match. In other embodiments, rather than using a vector based search methodology, search engine 120 can utilize less dynamic search methodologies that do not involve the creation of document vectors for the patent documents.

In the vector based search methodology described above, each patent document stored in patent collection 130 and/or shared workspace 140 can be associated with one or more document vectors. For example, since patent documents such as patents and patent publications usually have a defined number of sections for meeting statutory filing requirements, a distinct document vector can be created for each section of a patent document, enabling search engine 120 to tailor a search on specific sections of the patent document. Further, the document vectors can be adjusted to remove non-relevant words or phrases provided in the request to yield a smaller and more concise document vector, which can improve efficiency of query processing due to time not spent by search engine 120 processing the removed strings.

The search conducted by search engine 120 as specified in block 210 can also be supplemented by searching additional patent related data. In one embodiment, for example, search engine 120 can search shared workspace 140 for data generated and stored by search engine 120 based on usage of search engine 120 by multiple users in the organization.

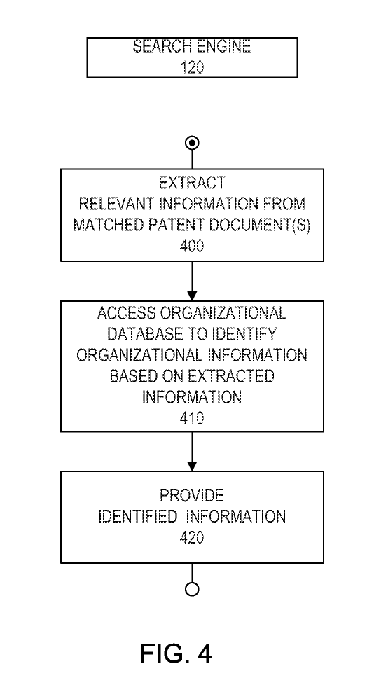

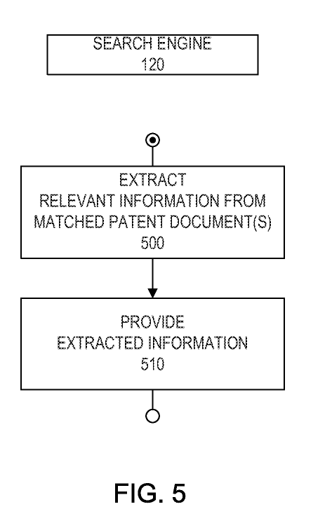

The ways in which search engine 120 can identify a technology center within the organization as specified in block 230 can be widely varied. In one embodiment, search engine 120 can cross-reference extracted patent document information with organizational resources to identify a technology center, as illustrated in the embodiment of FIG. 4. In another embodiment, search engine 120 can provide extracted patent document information to identify a technology center, as illustrated in the embodiment of FIG. 5.

In the embodiment illustrated in FIG. 4, search engine 120 can identify the requested technology center by extracting (block 400) relevant information from matched patent documents, accessing (block 410) an organizational database to identify organizational information based on the extracted information, and providing (block 420) the identified information to client 100. This manner of identifying a technology center can be advantageous when the technology center requested by client 100 comprises, for example, an employee associated with the organization and/or a division associated with the organization.

For example, in an embodiment in which the technology center requested by client 100 comprises an employee associated with the organization, search engine 120 can extract inventor information from matched patent documents, access organizational information 150 to identify whether any current or past employee of the organization matches the extracted inventor information, and provide any identified employee information to client 100. In an embodiment in which the technology center requested by client 100 comprises a division associated with the organization, search engine 120 can extract inventor information from matched patent documents, access organizational information 150 to identify whether any current or past employee of the organization matches the extracted inventor information and if so, what divisions of the organization are associated with the matched employees, and provide any identified division information to client 100. A division can include any unit associated with the organization, such as a corporate division (e.g., distinct corporate entity, such as an affiliated company) and an internal organizational unit (e.g., a department), for example.

In the embodiment illustrated in FIG. 5, search engine 120 can identify the requested technology center by extracting (block 500) relevant information from matched patent documents and providing (block 510) the extracted information to client 100. This manner of identifying a technology center can be advantageous when the technology center requested by client 100 comprises, for example, a technical solution. A technical solution can include any type of technical subject matter associated with the organization, such as a type of chemical coating that the organization manufactures. In an embodiment in which the technology center requested by client 100 comprises a technical solution associated with the organization, search engine 120 can extract technical solution information from matched patent documents, and provide any extracted technical solution information to client 100.

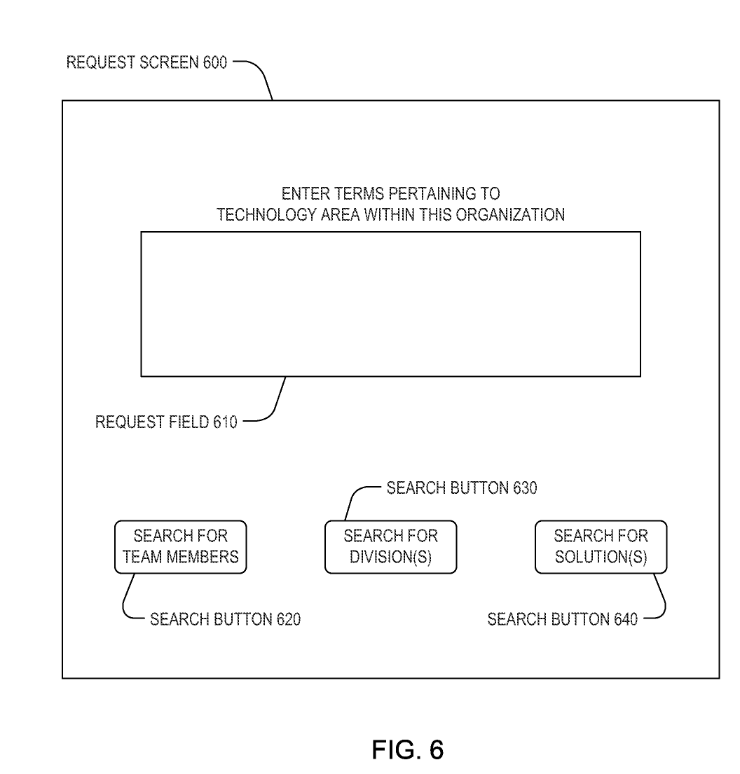

In addition to providing the requested technology center to client 100 as specified in block 230, search engine 120 can also provide a mechanism by which client 100 can contact or retrieve further information on the requested technology center identified by search engine 100. In particular, search engine 120 can provide a user interface that both identifies the requested technology center and enables client 100 to contact or retrieve further information on the requested technology center. Embodiments of exemplary user interfaces are illustrated in FIGS. 6-10. The illustrated user interfaces can be displayed on client 100 as part of computer-implemented workflow processes for example.

For example, FIG. 6 illustrates an embodiment of a user interface through which a user can request a technology center within the organization within which search engine 120 is deployed. The user interface can provide request screen 600, which can include request field 610 and search buttons 620, 630 and 640. Request field 610 can accept input constituting search terms from a user associated with the organization and operating client 100. The input can include data such as words, phrases or other textual description for example. After the search terms have been entered into request field 610, the user can click one of the search buttons, depending on which technology center the user desires. The clicking of the search button can act as an instruction to search engine 120 to request the desired technology center.

For example, clicking search button 620 (“Search for Team Members”) can instruct search engine 120 to locate any employees of the organization who are associated with subject matter having similarity to input search terms as described above. Clicking search button 630 (“Search for Team Division(s)”) can instruct search engine 120 to locate any division of the organization that is associated with subject matter having similarity to input search terms as described above. And clicking search button 640 (“Search for Team Solutions(s)”) can instruct search engine 120 to locate any technical solution associated with the organization having similarity to input search terms as described above.

Although not illustrated in FIG. 6, request screen 600 can also include a corporate tree specifying various corporate divisions of the organization that the user can select. By selecting one or more corporate divisions of the organization in request screen 600, search engine 120 can further narrow the search of patent documents to those associated with the selected corporate divisions (e.g., by appropriately adjusting the assignee field search limitation described above).

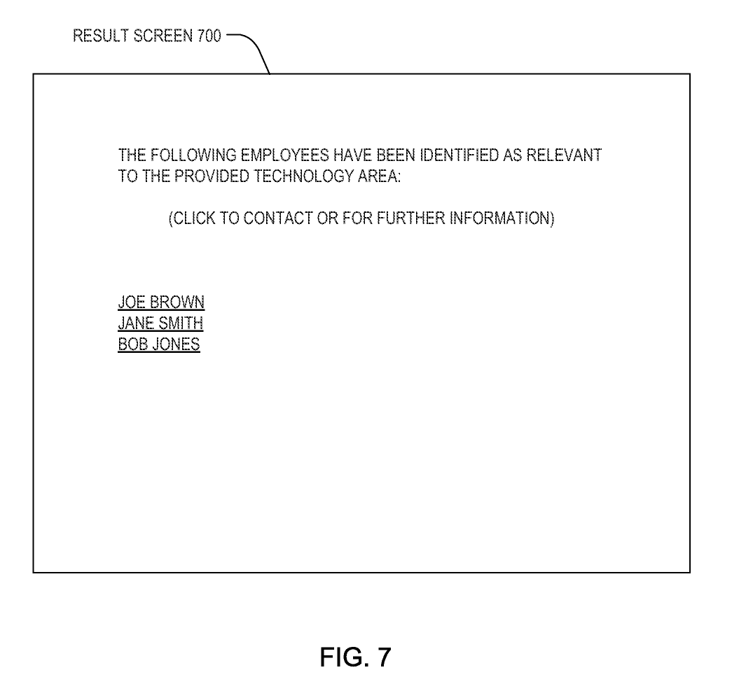

FIGS. 7-10 illustrate various embodiments of user interfaces through which search engine 120 can locate and provide the requested technology centers.

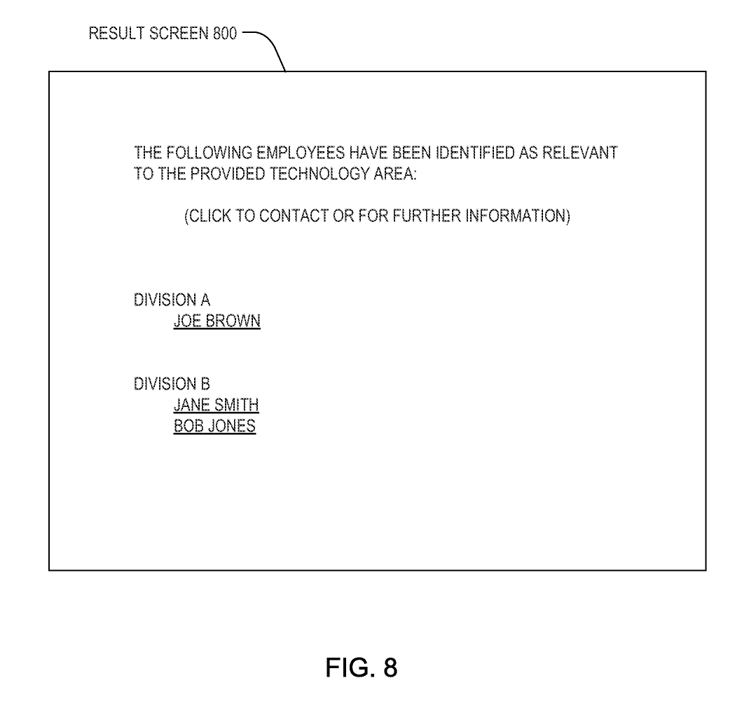

For example, FIG. 7 illustrates an example of a user interface through which search engine 120 can provide a requested technology center comprising an employee associated with the organization (e.g., in response to a request made by clicking search button 620 of request screen 600). As illustrated in FIG. 7, result screen 700 can identify employees identified by search engine 120 in the manner described above for example. The identified employees can also be organized by division within the organization, as illustrated in result screen 800 of FIG. 8. In this manner, the user interface can be configured to allow the user to select a particular division to expand the list of identified employees associated with the selected division. This can be advantageous when a large number of employees are identified in response to the user's request.

Further, result screen 700 can enable a user to select any of the identified employees to either retrieve contact information for, or be placed into contact with, the selected employees. For example, by selecting an identified employee, result screen 700 could initiate a telephone call, e-mail, chat or blogging session with the selected employee. The contact information and functionality can be provided via access to organizational information 150 for example.

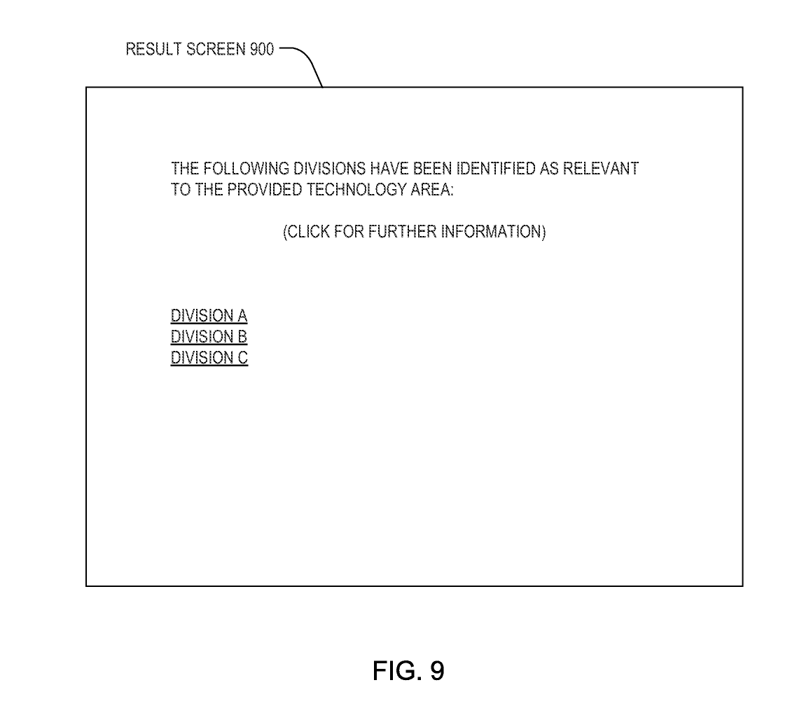

FIG. 9 illustrates an example of a user interface through which search engine 120 can provide a requested technology center comprising a division associated with the organization (e.g., in response to a request made by clicking search button 630 of request screen 600). As illustrated in FIG. 9, result screen 900 can identify divisions identified by search engine 120 in the manner described above for example. Result screen 900 can enable a user to select any of the identified divisions to retrieve descriptive and/or contact information for the selected divisions. For example, by selecting an identified division, result screen 900 could display organizational information about the selected division and contact information for a representative of the selected division. The descriptive and contact information can be provided via access to organizational information 150 for example.

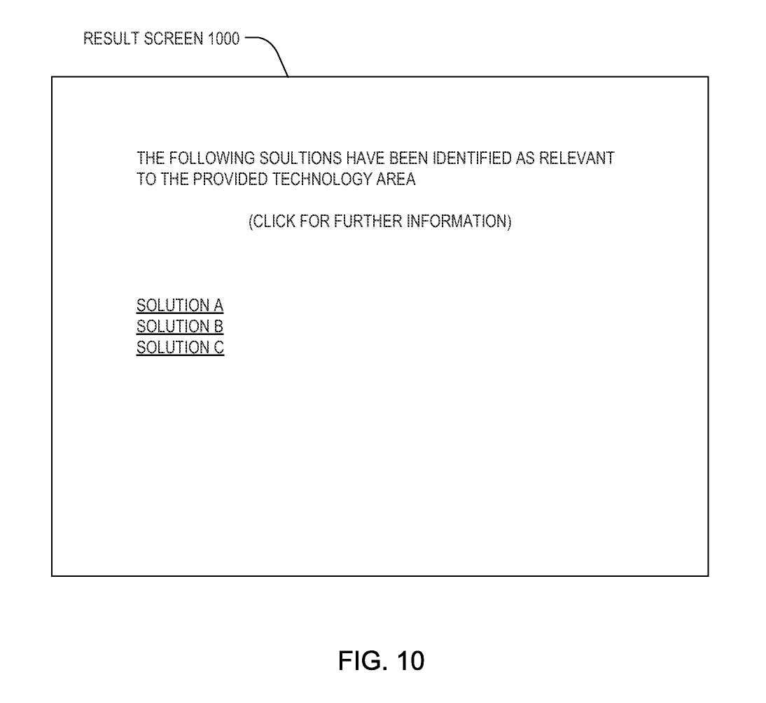

FIG. 10 illustrates an example of a user interface through which search engine 120 can provide a requested technology center comprising a technical solution associated with the organization (e.g., in response to a request made by clicking search button 640 of request screen 600). As illustrated in FIG. 10, result screen 1000 can identify technical solutions identified by search engine 120 in the manner described above for example. Result screen 1000 can enable a user to select any of the identified solutions to retrieve descriptive and/or contact information associated with the selected solutions. For example, by selecting an identified solution, result screen 1000 could display technical information about the selected solution and contact information for an employee associated with the solution within the organization. The technical and contact information can be provided via access to organizational information 150 for example.

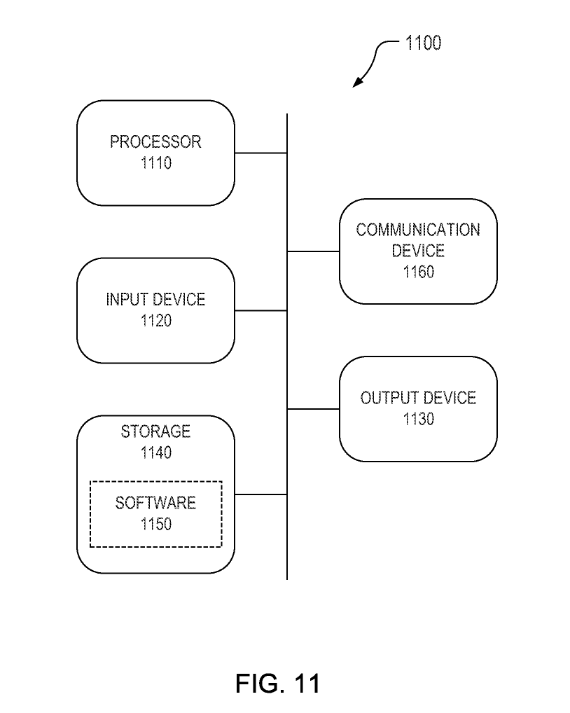

FIG. 11 shows a block diagram of an example of a computing device, which may generally correspond to client 100 and server 110. The form of computing device 1100 may be widely varied. For example, computing device 1100 can be a personal computer, workstation, server, handheld computing device, or any other suitable type of microprocessor-based device. Computing device 1100 can include, for example, one or more components including processor 1110, input device 1120, output device 1130, storage 1140, and communication device 1160. These components may be widely varied, and can be connected to each other in any suitable manner, such as via a physical bus, network line or wirelessly for example.

For example, input device 1120 may include a keyboard, mouse, touch screen or monitor, voice-recognition device, or any other suitable device that provides input. Output device 1130 may include, for example, a monitor, printer, disk drive, speakers, or any other suitable device that provides output.

Storage 1140 may include volatile and/or nonvolatile data storage, such as one or more electrical, magnetic or optical memories such as a RAM, cache, hard drive, CD-ROM drive, tape drive or removable storage disk for example. Communication device 1160 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1150 can be stored in storage 1140 and executed by processor 1110, and may include, for example, programming that embodies the functionality described in the various embodiments of the present disclosure. The programming may take any suitable form. For example, in one embodiment, programming embodying the patent document search functionality of search engine 120 can be based on an enterprise search platform, such as the Fast Enterprise Search Platform by Microsoft Corp. for example, and programming embodying the specialized workflows and user interfaces of the various embodiments can be based on a collaborative content management platform, such as SharePoint by Microsoft Corp. for example.

Software 1150 can also be stored and/or transported within any computer-readable storage medium for use by or in connection with an instruction execution system, apparatus, or device, such as computing device 1100 for example, that can fetch instructions associated with the software from the instruction execution system, apparatus, or device and execute the instructions. In the context of this document, a computer-readable storage medium can be any medium, such as storage 1140 for example, that can contain or store programming for use by or in connection with an instruction execution system, apparatus, or device.

Software 1150 can also be propagated within any transport medium for use by or in connection with an instruction execution system, apparatus, or device, such as computing device 1100 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A system comprising:
a search engine, executed by a microprocessor, which is configured to:
receive a request to identify a technology center within an organization, the request associated with search terms,
conduct a search of patent documents associated with the organization using the search terms, and
identify a technology center within the organization based on the search.

2. The system of claim 1, wherein the search engine is configured to identify the technology center by extracting information from a patent document resulting from the search,
accessing an organizational database associated with the organization to identify organizational information based on the extracted information, and
providing the identified information in response to the request.

3. The system of claim 2, wherein the technology center comprises an employee associated with the organization.

4. The system of claim 2, wherein the technology center comprises a division associated with the organization.

5. The system of claim 1, wherein the search engine is configured to identify the technology center by
extracting information from a patent document resulting from the search, and
providing the extracted information in response to the request.

6. The system of claim 5, wherein the technology center comprises a technical solution.

7. The system of claim 1, wherein the wherein the search engine is configured to conduct the search by comparing a vector associated with the search terms to a vector associated with each of the patent documents.

8. The system of claim 1, wherein the patent documents comprise a patent collection stored in a database.

9. The system of claim 1, wherein the patent documents are stored in a data store comprising a shared workspace accessible to multiple users in the organization.

10. The system of claim 9, wherein the shared workspace is associated with a division of the organization.

11. The system of claim 9, wherein the shared workspace comprises work files.

12. The system of claim 11, wherein the work files are associated with the multiple users.

13. The system of claim 11, wherein the work files are associated with projects associated with the organization.

14. The system of claim 9, wherein the data store stores data generated by the search engine based on usage of the search engine by the multiple users.

15. The system of claim 14, wherein the search engine is configured to conduct a search of the data generated by the search engine in response to the request.

16. A method, comprising:
receiving by a search engine executed by a microprocessor a request to identify a technology center within an organization, the request associated with search terms;
conducting by the search engine a search of patent documents associated with the organization using the search terms; and
identifying by the search engine a technology center within the organization based on the search.

17. The method of claim 16, wherein the identification of the technology center comprises
extracting information from a patent document resulting from the search,
searching an organizational database associated with the organization to identify organizational information based on the extracted information, and
providing the identified information in response to the request.

18. The method of claim 17, wherein the organizational database stores human resources data for the organization.

19. The method of claim 17, wherein the technology center comprises an employee associated with the organization.

20. The method of claim 17, wherein the technology center comprises a division associated with the organization.

21. The method of claim 16, wherein the identification of the technology center comprises
extracting information from a patent document resulting from the search, and
providing the extracted information in response to the request.

22. The method of claim 21, wherein the technology center comprises a technical solution.

23. A computer-readable storage medium storing instructions executable by a computer to:
receive a request to identify a technology center within an organization, the request associated with search terms;
conduct a search of patent documents associated with the organization using the search terms; and
identify a technology center within the organization based on the search.

24. A system comprising:
means for receiving a request to identify a technology center within an organization, the request associated with search terms;
means for conducting a search of patent documents associated with the organization using the search terms; and
means for identifying a technology center within the organization based on the search.

25. A transport medium encoding instructions executable by a computer to:
receive a request to identify a technology center within an organization, the request associated with search terms;
conduct a search of patent documents associated with the organization using the search terms; and
identify a technology center within the organization based on the search.
